(19) United States
(12) Patent Application Publication
(10) Pub. No.: US 2008/0226927 A1
(43) Pub. Date: Sep. 18, 2008

(54) DIELECTRIC CERAMICS AND MULTILAYER CERAMIC CAPACITOR

(75) Inventors: Kazumi Kaneda, Gunma (JP); Shusaku Ueda, Gunma (JP); Shinichiro Ikemi, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 12/033,806

(22) Filed: Feb. 19, 2008

(30) Foreign Application Priority Data
Feb. 19, 2007 (JP) 2007-38557

(51) Int. Cl. B32B 18/00; C03C 3/00

(52) U.S. Cl. 428/432; 501/32

(57) ABSTRACT

Dielectric ceramics and a multi-layer ceramic capacitor with internal Ni electrodes having a more improved property showing the reliability such as high accelerated life time than usual, a temperature characteristic of the permittivity satisfying the X6S property, and having a permittivity of from 800 to 1800, wherein the dielectric ceramics comprise a main ingredient within a range:

1.100≦Ba/Ti≦1.700
0.02≦a≦0.10
0.01≦b≦0.05
when represented as:

ABO₃+aRe+bM

(in which ABO₃ is a general formula for a perovskite structure, wherein the A cation sites are predominantly occupied by Ba and optionally one or more of Ca and Sr, and wherein the B cation sites are predominantly occupied by Ti and Zr, wherein Re represents at least one oxide of metals selected from La, Ce, Pr, Nd, Sm, Eu, Gd, Tb, Dy, Ho, Er, Tm, Yb, Lu, and Y, wherein M is an oxide of metal element selected from Mg, Al, Cr, Mn, Fe, Ni, Cu, and Zn, wherein a and b each represents the number of mols for each oxide based on 1 mol of ABO₃ when each oxide is converted into that of a chemical formula containing one metal element), and wherein the Zr is within a range, when represented as a ratio of Zr to Ti, of; Ti:Zr=95:5 to 60:40.

### BACKGROUND OF THE INVENTION

1. Field of the Invention

The present invention concerns dielectric ceramics mainly comprising barium titanate (BaTiO₃) and a multi-layer ceramic capacitor and using them to provide a multi-layer ceramic capacitor having internal electrodes constituted with Ni or an Ni alloy.

2. Description of Related Art

For multi-layer ceramic capacitors used in electronic equipments such as portable equipments and communication equipments, decrease in the size and increase in the capacity have been demanded more and more. For manufacturing a multi-layer ceramic capacitor small in the size and large in the capacity, Japanese Patent No. 3567759 discloses, for example, a dielectric ceramic composition comprising a perovskite structure and additive ingredients decreased in the loss and heat generation under high frequency and high voltage.

Further, Japanese Patent No. 3361531 proposes a dielectric ceramic composition mainly comprising barium titanate, capable of being burnt together with Ni in a reducing atmosphere, and having high permittivity.

In recent years, decrease in the size and increase in the capacitance have been demanded further for multi-layer ceramic capacitors and the thickness for one layer of ceramic layers after burning has reached a level of 10 μm or less and, further, 5 μm or less. The dielectric ceramic composition shown in JP No. 3567759 has a high accelerated life time and has sufficient reliability at the level of the thickness of a green sheet of 20 μm as described in the examples thereof, but it involves a problem that the property showing the reliability such as high accelerated life time is deteriorated at the level of a thickness for one layer of the ceramic layers of 10 μm or less after burning.

Further, while a low distortion capacitor with less distortion has been demanded in recent years, the dielectric ceramic composition shown in JP No. 3361531 has a permittivity as high as 7,000 or more and is suitable to increase of the capacity but it is not suitable to the application use for low distortion capacitors.

### SUMMARY OF THE INVENTION

In one embodiment, the dielectric ceramics having a property showing reliability such as high accelerated life time which is improved more than usual, having temperature characteristic of the permittivity satisfying the X6S property, and having a permittivity of about 800 to about 1,800, as well as a multi-layer ceramic capacitor with internal Ni electrodes.

In some embodiments, the dielectric ceramics can be a sintered body comprising a main ingredient within a range:

### 1.100≦Ba/Ti≦1.700

0.02≦a≦0.110
0.01≦b≦0.05
when represented as:

ABO₃+aRe+bM

(wherein ABO₃ is a general formula for a perovskite structure wherein the A cation sites are predominantly occupied by Ba and optionally one or more of Ca and Sr, and wherein the B cation sites are predominantly occupied by Ti and Zr, wherein Re represents at least one oxide of metals selected from La, Ce, Pr, Nd, Sm, Eu, Gd, Tb, Dy, Ho, Fr, Tm, Yb, Lu, and Y, wherein M is an oxide of metal element selected from Mg, Al, Cr, Mn, Fe, Ni, Cu, and Zn, wherein a and b each represents the number of mols for each oxide based on 1 mol of ABO₃ when each oxide is converted into that of a chemical formula containing one metal element), and wherein the Zr is within a range, when represented as a ratio of Zr to Ti, of;

Ti:Zr=95:5 to 60:40, and

SiO₂ or a glass ingredient comprising SiO₂ as a main ingredient in which SiO₂ or the glass ingredient mainly comprising SiO₂ can be within a range from of about 0.2 to about 5.0 parts by weight based on 100 parts by weight of the perovskite structure.

The Ba/Ti ratio represents the ratio of Ba and Ti contained in the perovskite structure, which does not always agree with the A/B ratio in the perovskite structure. For example, in a case of BaTiO₃ and (Ba_{1-x-y}CaₓSr_{y}) TiO₃, while the A/B ratio is 1 for both of them, the Ba/Ti ratio is 1 for BaTiO₃ but it is 1-x-y for (Ba_{1-x-y}CaₓSr_{y}) TiO₃. Further, “when each oxide is converted into a chemical formula containing one metal element” means conversion of a metal oxide containing two or more metal atoms in one molecule into an oxide having one metal atom in one molecule and, for example, Ho₂O₃ is converted as HoO_{3/2}.

In further embodiments, a multi-layer ceramic capacitor having a plurality of dielectric ceramic layers, internal electrodes each formed between the dielectric ceramic layers, and external electrodes electrically connected with the internal electrodes, is provided, in which the dielectric ceramic layer can be constituted with the dielectric ceramics described above, and the internal electrode can be formed of Ni or an Ni alloy.

In other embodiments, the dielectric ceramics that constitute a multi-layer ceramic capacitor having internal Ni electrodes that can be sintered at 1280° C. or lower, having a permittivity of 800 to 1800, and a temperature property that satisfies X6S.

Other embodiments can further improve the property showing reliability such as high accelerated life time load by specifying Ba/Ti compared with existent dielectric ceramics.

In further embodiments, dielectric ceramics can be applicable to a less distortion type multi-layer ceramic capacitor having a permittivity of about 800 to about 1800.

### BRIEF DESCRIPTION OF THE DRAWINGS

FIG. 1 is a schematic view showing a cross section of a multi-layer ceramic capacitor. The multi-layer ceramic capacitor (1), has multi-layer ceramics (2) with a plurality of dielectric ceramic layers (3) and internal electrodes (4) formed between the dielectric ceramic layers. External electrodes (5) are formed on both end surfaces of the multi-layer ceramics so as to be connected electrically with the internal electrodes A first plating layer (6) and a second plating layer (7) are optionally formed thereon.

### DESCRIPTION OF THE PREFERRED EMBODIMENTS

In some preferred embodiments, the dielectric ceramics of the invention can be a sintered product containing a perovskite structure, an Re ingredient (Re is at least one oxide of metals selected from La, Ce, Pr, Nd, Sm, Eu, Gd, Tb, Dy, Ho, Er, Tm, Yb, Lu, and Y), an M ingredient (M represents an oxide of a metal element selected from Mg, Al, Cr, Mn, Fe, Ni, Cu, and Zn) and a Zr oxide in the compositional ratio described above, with addition of SiO₂ or a glass ingredient mainly comprising SiO₂ as a sintering aid. The glass ingredient includes a Li₂O—SiO₂ type glass or B₂O₃—SiO₂ type glass.

Such dielectric ceramics can be obtained as described below. In some embodiments, BaCO₃, TiO₂, and ZrO₂ can be weighed and prepared as the starting material so as to provide a compositional ratio in the range of the invention. In this case, CaCO₃ or SrCO₃ may also be provided optionally. Further, BaZrO₃, CaZrO₃, or SrZrO₃ may optionally also be used instead of ZrO₂. The starting materials are wet-mixed with addition of water by using a ball mill, bead mill, or disper mill. The mixture can then be dried and calcined at 1,100 to 1,250° C. to obtain a perovskite structure,

An Re ingredient (for example, Ho₂O₃), an M ingredient (for example, MgO, MnO, MnCO₃, Mn₃O₄ may also be used) and a sintering aid (for example, SiO₂) are weighed so as to provide a compositional ratio in the range of the invention and can be added to the obtained perovskite structure, wet-mixed by a ball mill or the like, and calcined at 700 to 900° C. after drying, to obtain a dielectric ceramic powder. The obtained dielectric ceramic powder can be used for forming a dielectric ceramic layer of a multi-layer ceramic capacitor.

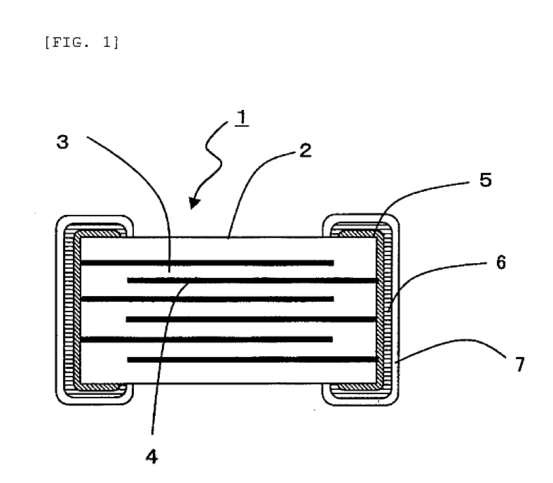

According to preferred embodiments, the multi-layer ceramic capacitor (1) according to this embodiment has, as shown in FIG. 1, multi-layer ceramics (2) comprising a plurality of dielectric ceramic layers (3) and internal electrodes (4) formed between the dielectric ceramic layers (3). External electrodes (5) can be formed on both end surfaces of the multi-layer ceramics (2) so as to be connected electrically with the internal electrodes (4), and a first plating layer (6) and a second plating layer (7) can be optionally formed thereon.

To manufacture a ceramic capacitor in accordance with embodiments of the invention, a starting material powder for forming the dielectric ceramics of the invention can be provided. This can be mixed with a butyral type or acrylic type organic binder, a solvent and other additives to form a ceramic slurry. The ceramic slurry can be sheeted by using a coating apparatus such as a roll coater to form a ceramic green sheet of a predetermined thickness as the dielectric ceramic layer. A conduction paste of Ni or an Ni alloy can be coated on the ceramic green sheet in a predetermined pattern shape by screen printing to form a conductor layer as the internal electrode.

In some embodiments, after laminating ceramic green sheets formed with the conductor layer by a required number of sheets, they can be press-bonded to form an uncalcined multi-layer body. After cutting and dividing the same into individual chips, they can be debound in an atmospheric air or a non-oxidative gas such as nitrogen. After debinding, a conduction paste may be applied to the surface of individual chips where the internal electrodes are exposed, to form a conductor film as the external electrode. The individual chips formed with the conductor film can be burnt in a nitrogen-hydrogen atmosphere (oxygen partial pressure at about 10⁻¹⁰ atm) at a predetermined temperature. The external electrode may also be formed by burning individual chips to form multi-layer ceramics, and then coating and baking a conduction paste containing glass frits to the surface of individual chips where the internal electrodes are exposed. For the external electrode, metals identical with those for the internal electrode can be used, as well as Ag, Pd, AgPd, Cu, Cu alloy, etc. can be used. Further, the first plating layer is formed with Ni, Cu, or the like on the external electrode, on which the second plating layer 7 is farther formed with Sn or Sn alloy to obtain the multi-layer ceramic capacitor.

### EXAMPLES

### Example 1

As the starting material, BaCO₃, TiO₂, ZrO₂, Gd₂O₃, and MgO were provided so as to obtain sintered bodies of the compositions shown in Table 1.

In Table 1, Ba, Ti, and Zr are represented by the ratios based on Ti+Zr being assumed as 100.

TABLE 1

| Specimen | | | | | Re:a | | M:b | | | | Aid |
|---|---|---|---|---|---|---|---|---|---|---|---|
| No. | Ba | Ti | Zr | Ba/Ti | Kind | Amount | Kind 1 | Amount | Kind 2 | Amount | SiO₂ |
| 101* | 102.0 | 94.0 | 6.0 | 1.085 | Gd | 0.08 | Mg | 0.025 | Mn | 0.005 | 1.5 |
| 102 | 100.1 | 91.0 | 9.0 | 1.100 | Gd | 0.08 | Mg | 0.025 | Mn | 0.005 | 1.5 |
| 103 | 102.0 | 60.0 | 40.0 | 1.700 | Gd | 0.04 | Mg | 0.025 | Mn | 0.005 | 3.0 |
| 104* | 105.0 | 60.0 | 40.0 | 1.750 | Gd | 0.04 | Mg | 0.025 | Mn | 0.005 | 3.0 |
| 105* | 107.0 | 97.0 | 3.0 | 1.103 | Gd | 0.06 | Mg | 0.025 | Mn | 0.005 | 1.5 |
| 106 | 105.0 | 95.0 | 5.0 | 1.105 | Gd | 0.04 | Mg | 0.025 | Mn | 0.005 | 1.5 |
| 107 | 101.5 | 60.0 | 40.0 | 1.693 | Gd | 0.04 | Mg | 0.025 | Mn | 0.005 | 3.0 |
| 108* | 93.0 | 55.0 | 45.0 | 1.691 | Gd | 0.04 | Mg | 0.025 | Mn | 0.005 | 3.0 |

*Out of the range of the invention

The BaCO₃, TiO₂, and ZrO₂ were wet-mixed by a ball mill and, after drying, calcined at 1,100° C. to obtain a perovskite structure. Then, Gd₂O₃, MgO, MnO, and SiO₂ were added to the perovskite structure so as to provide compositions shown in Table 1, wet-mixed by a ball mill and, after drying, calcined at 900° C. to obtain dielectric ceramic powders. In Table 1, the sintering aid is represented as parts by weight based on 100 parts by weight of the perovskite structure.

Polyvinyl butyral, an organic solvent, and a plasticizer were added to and mixed with each of the powders described above, to form ceramic slurries, Each ceramic slurry was sheeted by a roll coater to obtain a ceramic green sheet of 5 μm thickness. An internal Ni electrode paste was coated on the ceramic green sheet by screen printing to form an internal electrode pattern. The ceramic green sheets formed with the internal electrode pattern were stacked by the number of 21, press bonded and cut and divided each into a size of 4.0×2.0 mm to form uncalcined chips. The uncalcined chips were debound in a nitrogen atmosphere, coated with a Ni external electrode paste and burnt in a reducing atmosphere (nitrogen-hydrogen atmosphere, at an oxygen partial pressure of 10⁻¹⁰ atm) at a firing temperature shown in Table 2. For the multi-layer ceramic capacitors thus obtained each in the size of 3.2×1.6 mm and with a thickness of the dielectric ceramic layer of 3 μm, ∈r (permittivity), tan δ, temperature characteristics, mean life time as the evaluation for the reliability (high accelerated life time) were measured, which were collectively shown in Table 2. A mean life time test was conducted on every 15 specimens at 150° C. under a load of 25 V/μm and the mean life time was defined as a time when the insulation resistance value lowered to 1 MΩ or lower, and evaluated as “◯” in a case where all the specimens by the number of 15 showed a duration time of 48 hours or more. Data where measurement could not be conducted are indicated as “−”. The X6S property is a temperature characteristics in which the change of coefficient of the permittivity is within ±22% based on the permittivity (∈r) at 25° C. within a temperature range from −55° C. to 105° C. as a reference. Further, since the X6R property is a temperature characteristics in which the change of coefficient of the permittivity is within ±15% based on the permittivity (∈r) at 25° C. within a temperature range from 55° C. to +105° C. as a reference, those having the X6R property satisfy the X6S property. The temperature characteristics were determined by measuring the change of coefficient of the electrostatic capacity when based on the electrostatic capacity at 25° C. within a temperature range from 55° C. to 105° C. by utilizing the relation: permittivity=electrostatic capacity.

TABLE 2

| | Firing temperature | | | | Mean |
|---|---|---|---|---|---|
| Specimen No. | ° C. | εr | tan δ % | TCC | life time |
| 101* | 1250 | 1450 | 0.35 | X | — |
| 102 | 1250 | 1260 | 0.30 | X6S | ◯ |
| 103 | 1250 | 850 | 0.23 | X6S | ◯ |
| 104* | 1250 | — | — | — | — |
| 105* | 1250 | — | — | — | — |
| 106 | 1250 | 1700 | 0.31 | X6S | ◯ |
| 107 | 1250 | 870 | 0.22 | X6S | ◯ |
| 108* | 1250 | 700 | 0.21 | X6S | — |

*Out of the range of the invention

From the results described above, it can be seen that in a case where Ba/Ti is within a range from 1.100 to 1.700 and Ti:Zr is within a range from 95:5 to 60:40, dielectric ceramics and multi-layer ceramic capacitors with internal Ni electrode having a favorable mean life time, a temperature characteristic of the permittivity satisfying the X6S property, and a permittivity within a range from 800 to 1800 can be obtained. Specimens Nos. 104 and 105 could not be sintered.

### Example 2

Dielectric ceramic powders were formed in the same manner as in Example 1 so as to obtain sintered bodies of the compositions shown in Table 3. In this example, the addition amount of the Re ingredient was increased or decreased to verify the effect thereof.

TABLE 3

| Specimen | | | | | Re:a | | | | M:b | | | | Aid |
|---|---|---|---|---|---|---|---|---|---|---|---|---|---|
| No. | Ba | Ti | Zr | Ba/Ti | Kind 1 | Amount | Kind 2 | Amount | Kind 1 | Amount | Kind 2 | Amount | SiO₂ |
| 201 | 101.5 | 85.0 | 15.0 | 1.194 | La | 0.03 | Gd | 0.03 | Mg | 0.025 | Mn | 0.005 | 1.5 |
| 202 | 101.5 | 85.0 | 15.0 | 1.194 | Ce | 0.03 | Gd | 0.03 | Mg | 0.025 | Mn | 0.005 | 1.5 |
| 203 | 101.5 | 85.0 | 15.0 | 1.194 | Pr | 0.03 | Gd | 0.03 | Mg | 0.025 | Mn | 0.005 | 1.5 |
| 204 | 101.5 | 85.0 | 15.0 | 1.194 | Nd | 0.03 | Gd | 0.03 | Mg | 0.025 | Mn | 0.005 | 1.5 |
| 205 | 101.5 | 85.0 | 15.0 | 1.194 | Sm | 0.03 | Ho | 0.03 | Mg | 0.025 | Mn | 0.005 | 1.5 |
| 206 | 101.5 | 85.0 | 15.0 | 1.194 | Eu | 0.03 | Ho | 0.03 | Mg | 0.025 | Mn | 0.005 | 1.5 |
| 207 | 101.2 | 85.0 | 15.0 | 1.191 | Tb | 0.06 | — | — | Mg | 0.025 | Mn | 0.005 | 1.5 |
| 208 | 101.2 | 85.0 | 15.0 | 1.191 | Dy | 0.06 | — | — | Mg | 0.025 | Mn | 0.005 | 1.5 |
| 209 | 101.2 | 85.0 | 15.0 | 1.191 | Ho | 0.06 | — | — | Mg | 0.025 | Mn | 0.005 | 1.5 |
| 210 | 101.2 | 85.0 | 15.0 | 1.191 | Er | 0.04 | Gd | 0.02 | Mg | 0.025 | Mn | 0.005 | 1.5 |
| 211 | 101.2 | 85.0 | 15.0 | 1.191 | Tm | 0.04 | Gd | 0.02 | Mg | 0.025 | Mn | 0.005 | 1.5 |
| 212 | 101.2 | 85.0 | 15.0 | 1.191 | Yb | 0.04 | Gd | 0.02 | Mg | 0.025 | Mn | 0.005 | 1.5 |
| 213 | 101.2 | 85.0 | 15.0 | 1.191 | Lu | 0.04 | Gd | 0.20 | Mg | 0.025 | Mn | 0.005 | 1.5 |
| 214 | 101.2 | 85.0 | 15.0 | 1.191 | Y | 0.04 | Gd | 0.02 | Mg | 0.025 | Mn | 0.005 | 1.5 |
| 215* | 101.5 | 82.0 | 18.0 | 1.238 | Gd | 0.01 | — | — | Mg | 0.025 | Mn | 0.005 | 1.5 |
| 216 | 101.5 | 82.0 | 18.0 | 1.238 | Gd | 0.02 | — | — | Mg | 0.025 | Mn | 0.005 | 1.5 |
| 217 | 101.5 | 90.0 | 10.0 | 1.128 | Gd | 0.10 | — | — | Mg | 0.025 | Mn | 0.005 | 1.5 |
| 218* | 101.5 | 90.0 | 10.0 | 1.128 | Gd | 0.12 | — | — | Mg | 0.025 | Mn | 0.005 | 1.5 |

*Out of the range of the invention

In the same manner as in Example 1, the dielectric ceramic powders described above were formed into multi-layer ceramic capacitors, ∈r, tan δ, temperature characteristic, mean life time were measured, and they were collectively shown in Table 4.

TABLE 4

| Specimen | Firing temperature | | | | |
|---|---|---|---|---|---|
| No. | ° C. | εr | tan δ % | TCC | Mean life time |
| 201 | 1250 | 1160 | 0.21 | X6S | ◯ |
| 202 | 1250 | 1180 | 0.21 | X6S | ◯ |
| 203 | 1250 | 1190 | 0.22 | X6S | ◯ |
| 204 | 1250 | 1220 | 0.22 | X6S | ◯ |
| 205 | 1250 | 1220 | 0.24 | X6S | ◯ |
| 206 | 1250 | 1230 | 0.23 | X6S | ◯ |
| 207 | 1250 | 1480 | 0.29 | X6R | ◯ |
| 208 | 1250 | 1510 | 0.31 | X6R | ◯ |
| 209 | 1250 | 1490 | 0.31 | X6R | ◯ |
| 210 | 1250 | 1020 | 0.25 | X6R | ◯ |
| 211 | 1250 | 1050 | 0.24 | X6R | ◯ |
| 212 | 1250 | 1080 | 0.22 | X6R | ◯ |
| 213 | 1250 | 1100 | 0.20 | X6R | ◯ |
| 214 | 1250 | 1130 | 0.21 | X6R | ◯ |
| 215* | 1250 | 2150 | 0.31 | X | X |
| 216 | 1250 | 1550 | 0.30 | X6S | ◯ |
| 217 | 1250 | 830 | 0.21 | X6R | ◯ |
| 218* | 1250 | 670 | 0.19 | X6R | X |

*Out of the range of the invention

From the results described above, it can be seen that in a case where the compositional ratio for the Re ingredient, that is, a is within a range of: 0.02≦a≦0.10, dielectric ceramics and a multi-layer ceramic capacitors with internal Ni electrode having a favorable mean life time, a temperature characteristic of the permittivity satisfying the X6S property, and a permittivity within a range from 800 to 1800 can be obtained.

### Example 3

Dielectric ceramic powders were formed in the same manner as in Example 1 so as to obtain sintered bodies of the compositions shown in Table 5. In this example, the addition amount of the M ingredient was increased or decreased to verify the effect thereof.

TABLE 5

| Specimen | | | | | Re:a | | M:b | | | | Aid |
|---|---|---|---|---|---|---|---|---|---|---|---|
| No. | Ba | Ti | Zr | Ba/Ti | Kind | Amount | Kind 1 | Amount | Kind 2 | Amount | SiO₂ |
| 301 | 101.5 | 82.0 | 18.0 | 1.238 | Gd | 0.06 | Al | 0.030 | Mn | 0.005 | 1.5 |
| 302 | 101.5 | 82.0 | 18.0 | 1.238 | Gd | 0.06 | Cr | 0.030 | Mn | 0.005 | 1.5 |
| 303 | 101.5 | 82.0 | 18.0 | 1.238 | Gd | 0.06 | Fe | 0.030 | Mn | 0.005 | 1.5 |
| 304 | 101.5 | 82.0 | 18.0 | 1.238 | Gd | 0.06 | Ni | 0.030 | Mn | 0.005 | 1.5 |
| 305 | 101.5 | 82.0 | 18.0 | 1.238 | Gd | 0.06 | Cu | 0.030 | Mn | 0.005 | 1.5 |
| 306 | 101.5 | 82.0 | 18.0 | 1.238 | Gd | 0.06 | Zn | 0.030 | Mn | 0.005 | 1.5 |
| 307 | 101.5 | 82.0 | 18.0 | 1.238 | Gd | 0.06 | V | 0.020 | Mn | 0.005 | 1.5 |
| 308* | 101.5 | 82.0 | 18.0 | 1.238 | Gd | 0.06 | Mg | 0.0025 | Mn | 0.0025 | 1.5 |
| 309 | 101.5 | 82.0 | 18.0 | 1.238 | Gd | 0.06 | Mg | 0.005 | Mn | 0.005 | 1.5 |
| 310 | 101.5 | 82.0 | 18.0 | 1.238 | Gd | 0.06 | Mg | 0.045 | Mn | 0.005 | 1.5 |
| 311* | 101.5 | 82.0 | 18.0 | 1.238 | Gd | 0.06 | Mg | 0.055 | Mn | 0.005 | 1.5 |

*Out of the range of the invention

In the same manner as in Example 1, the dielectric ceramic powders described above were formed into multi-layer ceramic capacitors, ∈r, tan δ, temperature characteristic, mean life time were measured, and they were collectively shown in Table 6.

TABLE 6

| Specimen | Firing temperature | | | | |
|---|---|---|---|---|---|
| No. | ° C. | εr | tan δ % | TCC | Mean life time |
| 301 | 1250 | 1080 | 0.20 | X6S | ◯ |
| 302 | 1250 | 1100 | 0.21 | X6S | ◯ |
| 303 | 1250 | 1050 | 0.19 | X6S | ◯ |
| 304 | 1250 | 1070 | 0.19 | X6S | ◯ |
| 305 | 1250 | 1090 | 0.18 | X6S | ◯ |
| 306 | 1250 | 1050 | 0.19 | X6S | ◯ |
| 307 | 1250 | 1130 | 0.21 | X6S | ◯ |
| 308* | 1250 | 1200 | 0.23 | X | — |
| 309 | 1250 | 1150 | 0.20 | X6S | ◯ |
| 310 | 1250 | 900 | 0.19 | X6R | ◯ |
| 311* | 1250 | 830 | 0.18 | X6R | X |

*Out of the range of the invention

From the results described above, it can be seen that in a case where the compositional ratio for the M ingredient, that is, b is within a range of: 0.01≦b≦0.05, dielectric ceramics and multi-layer ceramic capacitors with internal Ni electrode having a favorable mean life time, a temperature characteristic of the permittivity satisfying the X6S property, and a permittivity within a range from 800 to 1800 can be obtained.

### Example 4

Dielectric ceramic powders were formed in the same manner as in Example 1 so as to obtain sintered bodies of the compositions shown in Table 7. In this example, the specimen number 408 is an example in JP No. 3567759 and the specimen No. 409 is a known composition. As the glass ingredient used as the sintering aid, B₂O₃—SiO₂—BaO glass was used.

TABLE 7

| Specimen | | A site | | | | | Re:a | | M:b | | | | Aid | |
|---|---|---|---|---|---|---|---|---|---|---|---|---|---|---|
| No. | Ba | substitution | | Ti | Zr | Ba/Ti | Kind | Amount | Kind 1 | Amount | Kind 2 | Amount | SiO₂ | Glass |
| 401* | 101.5 | — | — | 82.0 | 18.0 | 1.238 | Gd | 0.04 | Mg | 0.025 | Mn | 0.005 | 0.15 | — |
| 402 | 101.5 | — | — | 82.0 | 18.0 | 1.238 | Gd | 0.04 | Mg | 0.025 | Mn | 0.005 | 0.2 | — |
| 403 | 101.5 | — | — | 82.0 | 18.0 | 1.238 | Gd | 0.08 | Mg | 0.025 | Mn | 0.005 | 5.0 | — |
| 404* | 101.5 | — | — | 82.0 | 18.0 | 1.238 | Gd | 0.08 | Mg | 0.025 | Mn | 0.005 | 6.0 | — |
| 405 | 101.5 | — | — | 82.0 | 18.0 | 1.238 | Gd | 0.06 | Mg | 0.025 | Mn | 0.005 | — | 2.0 |
| 406 | 91.5 | Ca | 10.0 | 82.0 | 18.0 | 1.116 | Gd | 0.06 | Mg | 0.025 | Mn | 0.005 | 1.5 | — |
| 407 | 96.5 | Sr | 5.0 | 82.0 | 18.0 | 1.177 | Gd | 0.06 | Mg | 0.025 | Mn | 0.005 | 1.5 | — |
| 408* | 100.0 | — | — | 100.0 | 20.0 | 1.000 | Gd | 0.12 | Mg | 0.050 | Mn | 0.010 | — | 2.0 |
| 409* | 101.0 | — | — | 86.0 | 14.0 | 1.174 | Ho | 0.01 | Mg | 0.010 | Mn | 0.005 | — | 0.5 |

*Out of the range of the invention

In the same manner as in Example 1, the dielectric ceramic powders described above were formed into multi-layer ceramic capacitors, ∈r, tan δ, temperature characteristic, mean life time were measured, and they were collectively shown in Table 8.

TABLE 8

| Specimen | Firing temperature | | | | |
|---|---|---|---|---|---|
| No. | ° C. | εr | tan δ % | TCC | Mean life time |
| 401* | 1250 | — | — | — | — |
| 402 | 1250 | 1100 | 0.20 | X6S | ◯ |
| 403 | 1200 | 1300 | 0.25 | X6S | ◯ |
| 404* | 1200 | 1410 | 0.30 | X | — |
| 405 | 1200 | 1220 | 0.25 | X6S | ◯ |
| 406 | 1250 | 1200 | 0.21 | X6S | ◯ |
| 407 | 1250 | 1170 | 0.19 | X6S | ◯ |
| 408* | 1260 | 400 | 0.20 | X6R | X |
| 409* | 1280 | 6000 | 0.65 | X | — |

*Out of the range of the invention

From the results described above, it can be seen that in a case where the composition for the sintering aid is within a range from 0.2 to 5.0 parts by weight based on 100 parts by weight of the perovskite structure, dielectric ceramics and multi-layer ceramic capacitors with internal Ni electrode having a favorable mean life time, a temperature characteristic of the permittivity satisfying the X6S property, and a permittivity within a range from 800 to 1800 can be obtained.

From the result of the specimen No. 406, and the specimen No. 407, it can be seen that the effect of the invention can be provided in a case where Ba/Ti is within a range from 1.100 to 1.700 even when Ba is partially replaced with Ca or Sr. Further, it has been found that the dielectric ceramics and the multi-layer ceramic capacitors of the invention have excellent properties over those of existent products.

From the results described above, it has been found that the present invention can provide dielectric ceramics and multi-layer ceramic capacitors with internal Ni electrode having a more improved property showing the reliability such as a high accelerated life time compared with those of existent products, having a temperature characteristic of the permittivity satisfying the X6S property, and having a permittivity of 800 to 1800.

What is claimed is:

1. Dielectric ceramics as a sintered body comprising a main ingredient within a range:
1.100≦Ba/Ti≦1.700
0.02≦a≦0.10
0.01≦b≦0.05
when represented as:
ABO₃+aRe+bM
(in which ABO₃ is a general formula for a perovskite structure, wherein the A cation sites are predominantly occupied by Ba and optionally one or more of Ca and Sr, and wherein the B cation sites are predominantly occupied by Ti and Zr, wherein Re represents at least one oxide of metals selected from La, Ce, Pr, Nd, Sm, Eu, Gd, Tb, Dy, Ho, Er, Tm, Yb, Lu, and Y, wherein M is an oxide of metal element selected from Mg, Al, Cr, Mn, Fe, Ni, Cu, and Zn, wherein a and b each represents the number of mols for each oxide based on 1 mol of ABO₃ when each oxide is converted into that of a chemical formula containing one metal element), and the Zr is within a range, when represented as a ratio of Zr to Ti, of,
Ti:Zr=95:5 to 60:40, and
SiO₂ or a glass ingredient comprising SiO₂ as a main ingredient in which SiO₂ or the glass ingredient mainly comprising SiO₂ is within a range from about 0.2 to 5.0 parts by weight based on 100 parts by weight of the perovskite structure.

2. Dielectric ceramics according to claim 1, wherein the A sites of the perovskite structure are partially occupied by Sr and/or Ca.

3. A multi-layer ceramic capacitor having a plurality of dielectric ceramic layers, internal electrodes each formed between the dielectric ceramic layers, and external electrodes electrically connected with the internal electrodes, wherein
the dielectric ceramic layer is a sintered body comprising a main ingredient within a range:
1.100≦Ba/Ti≦1.700
0.02≦a≦0.10
0.01≦b≦0.05
when represented as:
ABO₃+aRe+bM
(in which ABO₃ is a general formula for a perovskite structure, wherein the A cation sites are predominantly occupied by Ba and optionally one or more of Ca and Sr, and wherein the B cation sites are predominantly occupied by Ti and Zr, wherein Re represents at least one oxide of metals selected from La, Ce, Pr, Nd, Sm, Eu, Gd, Tb, Dy, Ho, Er, Tm, Yb, Lu, and Y, wherein M is an oxide of metal element selected from Mg, Al, Cr, Mn, Fe, Ni, Cu, and Zn, wherein a and b each represents the number of mols for each oxide based on 1 mol of ABO₃ when each oxide is converted into that of a chemical formula containing one metal element), and wherein the Zr is within a range, when represented as a ratio of Zr to Ti, of;
Ti:Zr=95:5 to 60:40, and
SiO₂ or a glass ingredient comprising SiO₂ as a main ingredient in which SiO₂ or the glass ingredient mainly comprising SiO₂ is within a range from about 0.2 to 5.0 parts by weight based on 100 parts by weight of the perovskite structure, and the interned electrode is formed of Ni or a Ni alloy.
